(19) United States
(12) Patent Application Publication
(10) Pub. No.: US 2020/0290597 A1
(43) Pub. Date: Sep. 17, 2020

(54) METHOD AND SYSTEM FOR CONTROLLING THE PITCHING OF A MOTOR VEHICLE

(71) Applicant: C.R.F. Società Consortile per Azioni, Orbassano (Torino) (IT)

(72) Inventors: Giovanni GABIATI, Orbassano (Torino) (IT); Massimo GRILLO, Orbassano (Torino) (IT); Michele IELUZZI, Orbassano (Torino) (IT); Pier Paolo PARAVIZZINI, Orbassano (Torino) (IT); Nicola POERIO, Orbassano (Torino) (IT); Enrico RAFFONE, Orbassano (Torino) (IT)

(21) Appl. No.: 16/812,440

(22) Filed: Mar. 9, 2020

(30) Foreign Application Priority Data
Mar. 12, 2019 (EP) 19 162 246.3

(51) Int. Cl. B60W 30/02

(52) U.S. Cl. CPC B60W 30/02; B60W 2420/42; B60W 2552/35; B60R 11/04; B60W 2720/125; B60W 2720/16; B60W 2720/106

(57) ABSTRACT

A system and method for controlling a balance of a moving motor vehicle whose pitching motion when overcoming an unevenness of the road is corrected by means of an acceleration and/or a deceleration of the vehicle by a value correlated to a level of unevenness of the road. The level of unevenness is detected by monitoring the road ahead of the moving vehicle and the pitching motion is predictively corrected based on such monitoring.

### FIELD OF THE INVENTION

The present invention generally regards the control of the balance of a motor vehicle and more in particular it regards the correction of the pitching motion to which a moving vehicle is subjected when overcoming the unevenness of the road.

Typically, the unevenness could for example consist of a so-called speed bumps or speed reducers consisting of a bump arranged transversely to the direction of travel and having the function of slowing down the speed in urban areas. Other unevenness could for example consist in ditches on the road bed or in reliefs and depressions that could form, even naturally, along untarmacked roads.

When travelling through unevenness of this kind, the vehicle, and more precisely its suspended mass, is subjected to more or less sudden and intense jolts obviously depending on the disparity with respect to the road surface and the vehicle advancement speed.

It is thus desirable to be able to compensate and reduce the pitching motion to which the vehicle is subjected under such circumstances, with the aim of improving the comfort for the occupants thereof.

### STATE OF THE ART

Documents EP2808214 A1 and EP2829424 A1 reveal solutions for correcting the balance of the suspended mass of the vehicle depending on the pitching, as well as other unwanted movements. The solution proposed in these documents essentially consists in monitoring the speed variations of the wheels of the vehicle due to impact with the road unevenness and in thus correcting the balance of the suspended mass both with possible variation of the speed of the vehicle (acceleration or deceleration) and acting on the damping features of the shock absorbers, which—to this end—must be provided with special devices for varying the degree of damping.

Thus, this prior art technique of the reactive type, given that the correction of the balance occurs upon the impact of the wheels of the vehicle with the road unevenness, which thus entails functional difficulties in terms of obtaining an almost instantaneous correction. Two threshold values, one smaller than the other, of the monitored quantity are set: below the lower threshold the system reacts with the acceleration of the engine and thus of the vehicle, while above the upper threshold values the system reacts with a braking of the vehicle. As concerns values comprised between the lower threshold and the upper threshold the system reacts by changing the damping effect of the shock absorbers. Thus, besides the aforementioned functional difficult, there is also the further complication regarding the need to equip the vehicle with variable damping shock absorbers.

### SUMMARY OF THE INVENTION

The object of the present invention is to overcome the drawbacks of the prior art, and providing a method for controlling the pitching motion of a motor vehicle when overcoming an uneven road that is simpler but simultaneously not less effective with respect to the known aforementioned methods, without entailing the need to act on the damping features of the shock absorbers.

According to the distinctive characteristic of the invention, the method for controlling the balance of a moving vehicle, whose pitching—when overcoming an uneven road—is corrected by means of accelerations and/or decelerations, lies in the fact that the unevenness profile is detected by monitoring the road ahead of the moving vehicle and the pitching motion is predictively corrected based on such monitoring.

The distinctiveness of the predictive control instead of the reactive control of the method according to the invention makes the control of the balance considerably easier and extremely effective at the same time.

According to the invention the method comprises, more in detail, the following operations:
equipping the vehicle with a front video camera configured to monitor the road of the vehicle and for detecting the unevenness of such road,
processing the video shots made by the video camera for determining the detected unevenness profile and estimate the level of pitching of the vehicle provided based on the advancement speed thereof,
controlling, even before overcoming the unevenness, a sequence of accelerations and decelerations of the vehicle as a function of the profile thus determined and the speed of the vehicle, so as to reduce the pitching motion thereof.

The invention also regards a control system for the implementation of the method, which is configured to detect the unevenness by monitoring the road ahead of the moving vehicle and for predictively correcting the pitching motion based on such monitoring.

### BRIEF DESCRIPTION OF THE DRAWINGS

The invention will now be described in detail with reference to the attached drawings, provided purely by way of non-limiting example, wherein:

FIG. 1 is a schematic view showing a motor vehicle configured for implementing the method according to the invention, and

FIG. 2 is a block diagram exemplifying the components of the system for implementing the control method.

### DETAILED DESCRIPTION OF THE INVENTION

The distinctive feature of the control method and system according to the invention lies, as previously mentioned, in the fact that the correction of the pitching motion of a motor vehicle A when overcoming an unevenness B of the road R, typically a speed reducer, is predictively corrected by monitoring the level of unevenness, by estimating the expected pitching of the vehicle and thus correcting it by means of a sequence of accelerations and decelerations, i.e. by acting solely on the engine and possibly on the braking system of the vehicle without requiring the use of auxiliary devices for example applied to the shock absorbers of the vehicle wheels.

In order to monitor the unevenness B, the vehicle A is equipped, according to the invention, with a video camera C positioned frontally or at an area such to be able to view and film the road R ahead of the moving vehicle.

With reference to FIG. 2, in the control system according to the invention the signals coming from the video camera C are processed by means of an image processor P to determine the unevenness characteristics, in particular in terms of the profile of the surface of the road R. The processor P is operatively connected to a control unit U with which the vehicle A is normally provided, in turn connected to a speed sensor S which detects the advancement speed of the motor vehicle and to an engine control unit E as well as to a braking system control unit F for the wheels of the vehicle A.

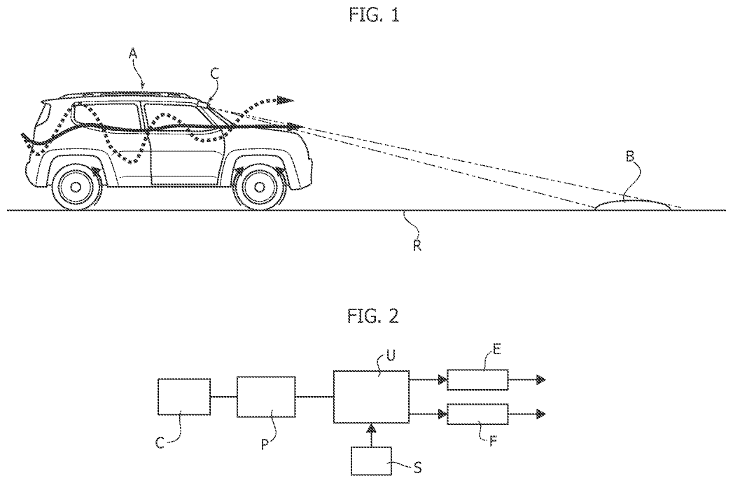

In use, through the images taken by the video camera C, the processor P estimates the profile or geometry of the unevenness B and the level of pitching of the vehicle A predicted depending on the advancement speed thereof. Thus, the control unit U acts on the engine control unit E and possibly on the braking system control unit F to impart to the motor vehicle A, even before overcoming the unevenness (B), a short sequence of accelerations and/or decelerations or brakings as a function of the detected unevenness profile B and the advancement speed thereof. Once the motor vehicle A overcomes the unevenness B it will thus be subjected to a short and almost instantaneous sequence of decelerations and accelerations depending on the unevenness profile B. In this manner, the pitching motion of the motor vehicle A when overcoming the unevenness B is corrected and reduced by an amount such to ensure to the occupants of the motor vehicle A a better driving comfort when overcoming obstacles such as, as mentioned, speed bumps and as well as ditches, portholes naturally uneven and bumpy paths along untarmacked roads. The lines respectively represented as dashed and solid in FIG. 1 schematically and qualitatively represent the pitching oscillations of the motor vehicle A upon overcoming the unevenness B respectively without control and with the control operated according to the invention.

Obviously, the construction details and the embodiments of the control system according to the invention may widely vary with respect to what has been described and illustrated, without departing from the scope of protection of the present invention as defined in the claims that follow.

1. A method for controlling a balance of a moving motor vehicle, the method comprising:
correcting a pitching motion of the moving vehicle when overcoming an unevenness of a road by means of accelerations and/or decelerations of the moving vehicle by a value correlated to the unevenness of the road, wherein an unevenness profile is determined based on monitoring the road ahead of the moving vehicle and the pitching motion is predictively corrected based on such monitoring.

2. The method according to claim 1, further comprising:
equipping the vehicle with a video camera configured to monitor the road ahead of the vehicle and for detecting the a level of unevenness of the road,
processing video shots made by said video camera to determine the unevenness profile and estimating a level of pitching motion of the vehicle provided based on an advancement speed of the vehicle, and
controlling, even before overcoming the unevenness of the road, a sequence of decelerations and accelerations of the vehicle as a function of the determined unevenness profile and the advancement speed of the vehicle, so as to reduce the pitching motion of the vehicle.

3. The method according to claim 1, wherein the vehicle is decelerated or accelerated based on the unevenness profile.

4. A system for controlling a balance of a moving motor vehicle when overcoming an unevenness of a road by means of an acceleration and/or a deceleration of the vehicle by a value correlated to a level of unevenness of the road, the system comprising:
a control system operatively configured to detect the level of unevenness of the road by monitoring the road ahead of the moving vehicle and predictively correcting a pitching motion of the vehicle based on said monitoring.

5. The system according to claim 4, wherein the vehicle comprises an engine, a braking system, an engine control unit a braking system control unit, and a video camera all operatively associated with the control system,
wherein the video camera is configured to monitor the road ahead of the vehicle and detect the level of unevenness of the road, and
wherein the control system includes a processing unit operatively connected to said video camera, to the engine control unit and to the braking system control unit and configured to determine an unevenness profile based of the detected level of unevenness of the road by the video camera and control, even before overcoming the unevenness of the road, a sequence of decelerations and accelerations of the vehicle as a function of the unevenness profile and an advancement speed of the vehicle, so as to reduce the pitching motion of the vehicle.

6. (canceled)

7. The system according to claim 5, wherein the control system is configured to reduce the pitching motion of the vehicle by the sequence of decelerations and accelerations of the vehicle as a function of the unevenness profile and an advancement speed of the vehicle without controlling or acting on dampening features of shock absorbers of the vehicle.
